(19) United States
(12) Patent Application Publication
(10) Pub. No.: US 2025/0203342 A1
(43) Pub. Date: Jun. 19, 2025

(54) ELECTRONIC SUBSCRIBER IDENTITY MODULE SERVICE SEGREGATION AND CONVEYANCE

(71) Applicant: AT&T Intellectual Property I, L.P., Atlanta, GA (US)

(72) Inventors: Yupeng Jia, South Pasadena, CA (US); Eric Zavesky, Austin, TX (US); James Pratt, Round Rock, TX (US)

(21) Appl. No.: 18/540,745

(22) Filed: Dec. 14, 2023

(51) Int. Cl. H04W 8/18; H04W 8/20; H04W 8/22; H04W 76/10

(52) U.S. Cl. CPC H04W 8/183; H04W 8/20; H04W 8/22; H04W 76/10

(57) ABSTRACT

A first integrated circuit of a mobile computing device may detect at least a first condition for enabling a utilization of at least one subscriber identity module credential stored on the first integrated circuit by a second computing device and may select the at least one subscriber identity module credential for transmission based upon the at least the first condition. The first integrated circuit may then establish a communication channel with a second integrated circuit of the second computing device and transmit the at least one subscriber identity module credential to the second integrated circuit via the communication channel to enable the utilization of the at least one subscriber identity module credential by the second computing device.

The present disclosure relates generally to cellular networks, and more particularly to methods, non-transitory computer-readable media, and apparatuses for a first integrated circuit of a mobile computing device to transmit at least one subscriber identity module credential to a second integrated circuit of a second computing device to enable the utilization of the at least one subscriber identity module credential by the second computing device.

### BACKGROUND

Wireless network users increasingly expect and demand access to subscribed services regardless of location. In many cases, mobile smartphones may fulfill users' needs. However, limitations of mobile smartphones in terms of screen size, lack of physical keyboard or other interfaces, limited processing capability (e.g., as compared to personal computers, or the like), and others may result in less efficient utilization of various subscribed services, such as video or other content streaming services, video gaming services, and so forth. In addition, there are an increasing number of cellular-capable endpoint device types (e.g., smart appliances, connected vehicles, other Internet of things (IoT) and/or biometric sensor devices, etc.). However, the cost, desire, and means to maintain always-on cellular connectivity for such devices may be impractical for many users.

### SUMMARY

In one example, the present disclosure describes devices, computer-readable media, and methods for a first integrated circuit of a mobile computing device to transmit at least one subscriber identity module credential to a second integrated circuit of a second computing device to enable the utilization of the at least one subscriber identity module credential by the second computing device. For instance, a first integrated circuit of a mobile computing device may detect at least a first condition for enabling a utilization of at least one subscriber identity module credential stored on the first integrated circuit by a second computing device and may select the at least one subscriber identity module credential for transmission based upon the at least the first condition. The first integrated circuit may then establish a communication channel with a second integrated circuit of the second computing device and transmit the at least one subscriber identity module credential to the second integrated circuit via the communication channel to enable the utilization of the at least one subscriber identity module credential by the second computing device.

### BRIEF DESCRIPTION OF THE DRAWINGS

The teaching of the present disclosure can be readily understood by considering the following detailed description in conjunction with the accompanying drawings, in which:

FIG. 1 illustrates an example network or system related to the present disclosure;

FIG. 2 illustrates a flowchart of an example method for a first integrated circuit of a mobile computing device to transmit at least one subscriber identity module credential to a second integrated circuit of a second computing device to enable the utilization of the at least one subscriber identity module credential by the second computing device; and

FIG. 3 illustrates an example high-level block diagram of a computer specifically programmed to perform the steps, functions, blocks, and/or operations described herein.

To facilitate understanding, identical reference numerals have been used, where possible, to designate identical elements that are common to the figures.

### DETAILED DESCRIPTION

Devices, computer-readable media, and methods for a first integrated circuit of a mobile computing device to transmit at least one subscriber identity module credential to a second integrated circuit of a second computing device to enable the utilization of the at least one subscriber identity module credential by the second computing device are disclosed. To illustrate, examples of the present disclosure provide an integrated circuit, e.g., a universal integrated circuit card (UICC), a subscriber identity module (SIM), an eSIM, an iSIM, or the like, that may segregate connectivity or other subscriber identity module (SIM) features from a device or set of services, e.g., associated with a subscriber or other entities. For instance, examples of the present disclosure may enable a cellular network operator to provide one or more services on different UICCs, where access to SIM profile(s)/features may be conditional on other attributes. To further illustrate, a cellular network operator may enable a user to link the user's identity and subscribed services across one or more UICCs via SIM credentials that may be propagated from one device (e.g., from a UICC thereof) to a different device (e.g., to a UICC thereof), such as a proximate mobile device, a home computer, a smart appliance and/or an Internet of things (IoT) device, and so forth.

In one example, a user interface may represent a SIM (e.g., an eSIM) or features/credentials thereof as a visual icon with the ability to receive/send/interact, e.g., using input(s) via a graphical user interface (GUI). In one example the SIM credential(s) may be represented as a virtual reality (VR)/augmented reality (AR) token (e.g., with the ability to direct a device and/or UICC thereof to receive and deliver SIM credentials to/from other devices/UICCs via a gesture, gaze, voice command, proximity measure, device-to-device tapping, and so forth). In one example, the transfer of SIM credentials amounting to less than all of the features of a SIM, SIM profile, and/or the contents of a UICC may provide the ability to block selected services or to force selected services through certain networks or functionalities when SIM credentials are used on a receiving device (e.g., blocking certain service type(s) in a school or business, forcing certain features to use connectivity via a capable local, non-cellular network, etc.). In one example, a cellular network may be configured to decline connectivity of certain types when received from certain devices using a “borrowed” SIM credential, may be configured to mandate a certain set of configuration parameters, may be configured to decline to activate a service pending a presentation of identity information to the network from the device, and so forth.

The use of eSIMs, e.g., on iUICCs, obviates the use of removable physical SIMs in cellular endpoint devices. In addition, activation of eSIMs is relatively easy with several authentication steps. However, one aspect of the eSIM procurement process, such as when purchasing a new cellular endpoint device, transferring a service to a different carrier/network operator, etc. is that the experience lacks the physical interaction associated with obtaining and installing a new physical SIM, e.g., a SIM card. In this regard, in one example, the present disclosure may provide a temporary eSIM activation based on a physical entry into a space, a logical interaction in a VR environment, and so forth.

Examples of the present disclosure enable conveyance of services via dynamically updatable eSIMs, which are in whole or in part fluidly transferable between devices via direct interactions (e.g., via peer-to-peer wireless communication), via interactions of digital representations, e.g., in a VR/AR environment, and so forth. In one example, transfer of partial SIM capabilities may be realized through full or partial SIM locking (e.g., using one or more passcodes), via refraining from sending all SIM files that are part of an eSIM file system, and so forth. In one example, a partial transfer may be enabled and/or reinforced on the network side by selectively blocking a particular type of service connectivity (e.g., blocking service type(s) in a school or business, forcing certain features to use connectivity via a capable local, non-cellular network, etc.). In one example, transfer of all or some SIM credentials may be validated by the user, e.g., via explicit confirmation via additional voice command(s), via an authentication/validation application, and so forth. In one example, SIM credentials may be represented as independent virtual objects that can be associated and dis-associated with one another and/or with virtual objects representing other devices or users, e.g., via user input in an AR/VR environment to manipulate the respective virtual objects, or similar input(s) via a graphical user interface (GUI), voice commands, or the like. For example, an eSIM (or credentials thereof) may be represented as one or more visual icons that can be added to different systems via a “drag and drop” operation, thereby allowing easier transfer or sharing to other devices. In one example, different gestures, proximity measure, and/or other physical actions may be associated with different permissions.

Similarly, examples of the present disclosure may enable limited network connectivity for specific events in accordance with a transferred SIM credential, or credentials, such as enabling a limited file copy capability over the cellular network, allowing limited access to connect to upload media, allowing a connection to offload IoT sensor data (but not for other types of connectivity), and so on. In one example, a conditional transfer of eSIM connectivity may be predicated on gestures or other sensed actions (e.g., a tap, swipe, etc.) on the receiving device (e.g., orientation of a device in a certain direction, presence within an audio range, visual gaze in a particular direction, etc.). In one example, a conditional transfer of eSIM connectivity may be geofenced. For example, when a receiving device leaves an area, the temporary utilization of transferred SIM credentials may expire.

In one example, a transferrable SIM feature may comprise a presence identification service that may provide identity information (e.g., for authentication, for location tracking at the direction of the user, etc.) without providing network connectivity for user data. For instance, this may be used while travelling to avoid roaming. However, content may be delivered to the endpoint device via non-cellular access networks when available. In one example, public terminals may be made available that can receive SIM credentials temporarily and that can present all or a subset of available content for a user, e.g., grandparents may be travelling abroad for an extended period of time and may view pictures from their grandchildren via temporary access at a public terminal by temporary transfer of SIM credentials to the public terminal. The UICC of the public terminal may be configured to erase the SIM profile and/or any SIM credentials after each use. In one example, the present disclosure may also provide for linking a user identity across associated SIM profiles for simplified phone setup, transfer of contacts, preferred roaming lists, and so forth.

As noted above, in one example, eSIM enablement may be facilitated with VR/AR interaction where one or more virtual objects may represent devices or SIM features. For instance, moving together a virtual object representing a device with a virtual object representing a connectivity feature may indicate that the connectivity feature should be associated with the device. In one example, a device may include an AR/VR application to enable the user to provide these inputs. In one example, the AR/VR application may communicate with a dedicated SIM applet that can receive instructions in accordance with the gestures or other AR/VR interactions and reconfigure a UICC and/or SIM accordingly, and that may cause the sharing of SIM credentials/features with one or more external devices (e.g., having their own, different UICCs). In one example, a user may permit a remote session with a customer support system to start a VR session via which the user may be assisted to install a new eSIM and/or to transfer SIM credentials to one or more other devices. For instance, via such a shared session, customer support may guide the user and/or perform tasks on behalf of the user, e.g., with the user's permission. In one example, such AR/VR interactions may be used for installing a new eSIM, e.g., where a local “blank” SIM, or default/bootstrap profile facilitates network connectivity to obtain new eSIM credentials (e.g., under the guidance of customer care and/or by the user directly, if the user is experienced and/or comfortable with learning such a new installation procedure). In one example, virtual interactions may have rules to impose connectivity through a software/service. For instance, a rule may be created such that to enter “level 12” in a virtual environment, a user must use specific network or other device service connectivity via the eSIM.

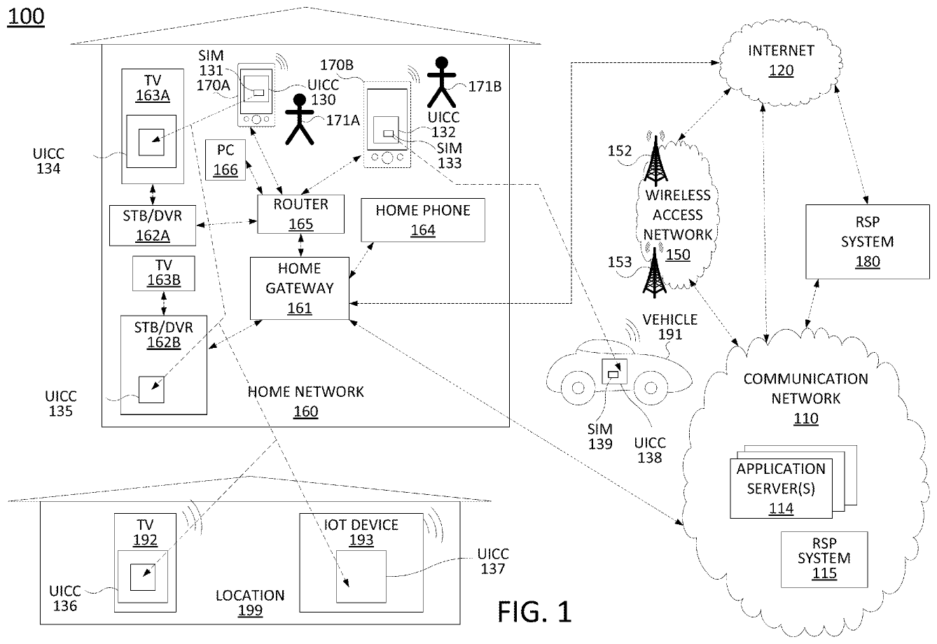

Thus, examples of the present disclosure enable transfer and temporary utilization of SIM credentials among devices through physical interaction with one or more of the devices (e.g., proximity measure, gesture, gaze, etc.). Examples of the present disclosure also enable the defining of partial SIM profiles (e.g., sets of one or more SIM credentials) for different user scenarios, e.g., selectively blocking/disabling certain capabilities. In addition, examples of the present disclosure diversify and simplify the user experience via offering SIM credentials or other identities in digital forms for unique interactions (e.g., as a visual icon or as a VR/AR token, etc.). In one example, as an alternative to a specific eSIM, a credential may comprise a container that may possess or execute certain software, either as part of itself or as part of a smart contract. In one example, an eSIM may be allocated to two or more devices that may share the eSIM according to respective assigned time slots. In one example, transferring of SIM credentials from device to device may permit a parent to enable temporary cellular service on a child's device, such as leaving the child at a sporting event, school, or the like, where the temporary cellular service may be revoked when the parent reconnects with the child, e.g., through device-to-device tapping, gesture, etc. and/or via expiration of a designated time period for utilization. These and other aspects of the present disclosure are discussed in greater detail below in connection with the examples of FIGS. 1-3.

To aid in understanding the present disclosure, FIG. 1 illustrates an example system 100 in which examples of the present disclosure may be implemented. As shown in FIG. 1, the system 100 connects mobile devices 170A and 170B and home network devices such as home gateway 161, set-top boxes (STBs) 162A, and 162B, television (TV) 163A and TV 163B, home phone 164, router 165, personal computer (PC) 166, and so forth, with one another and with various other devices via a communication network 110, a wireless access network 150 (e.g., a cellular network), and Internet 120.

In one example, either or both of the mobile devices 170A and 170B may comprise a subscriber/customer endpoint device configured for wireless communication such as a laptop computer, a Wi-Fi device, a Personal Digital Assistant (PDA), a mobile phone, a smartphone, an email device, a computing tablet, a messaging device, and the like. In one example, either or both of the mobile devices 170A and 170B may have both cellular and non-cellular access capabilities and may further have wired communication and networking capabilities. In one example, mobile devices 170A and 170B may be used by users 171A and 171B, respectively, who may be associated with one another as family members, e.g., parents and children, as friends, as co-workers, as caregiver and charge(s), and so forth.

In one example, communication network 110 may combine core network components of a cellular network with components of a triple play service network; where triple-play services include telephone services, Internet services, and television services to subscribers. For example, communication network 110 may functionally comprise a fixed mobile convergence (FMC) network, e.g., an IP Multimedia Subsystem (IMS) network. In addition, communication network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Communication network 110 may also further comprise a broadcast television network, e.g., a traditional cable provider network or an Internet Protocol Television (IPTV) network, as well as an Internet Service Provider (ISP) network. For example, with respect to television service provider functions, application servers 114 may represent one or more television servers for the delivery of television content, e.g., a broadcast server, a cable head-end, and so forth. For instance, communication network 110 may comprise a video super hub office, a video hub office and/or a service office/central office. With respect to cellular core network functions, application servers 114 may represent a Home Subscriber Server/Home Location Register (HSS/HLR) for tracking cellular subscriber device location and other functions, a serving gateway (SGW), a packet data network gateway (PGW or PDN GW), a mobility management entity (MME), and so forth. Application servers 114 may further represent an IMS media server (MS) for handling and terminating media streams to provide services such as announcements, bridges, and Interactive Voice Response (IVR) messages for VoIP and cellular service applications. As shown in FIG. 1, communication network 110 may also include a remote SIM provisioning (RSP) system 115, described in greater detail below. For ease of illustration, various additional elements of communication network 110 are omitted from FIG. 1.

In one example, wireless access network 150 comprises a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network 150 may comprise an access network in accordance with any “second generation” (2G), “third generation” (3G), “fourth generation” (4G), Long Term Evolution (LTE), “fifth generation” (5G), or any other yet to be developed future wireless/cellular network technology. While the present disclosure is not limited to any particular type of wireless access network, in the illustrative embodiment, wireless access network 150 is shown as a UMTS terrestrial radio access network (UTRAN) subsystem. Thus, base stations 152 and 153 may each comprise a Node B or evolved Node B (eNodeB), a gNB, or the like. As illustrated in FIG. 1, mobile devices 170A and 170B may be in communication with one or both of the base stations 152 and 153, which provide connectivity between the mobile devices 170A-170B and other endpoint devices within the system 100, various network-based devices, such as remote SIM provisioning (RSP) system 115, application servers 114, and so forth. In one example, wireless access network 150 may be operated by the same or a different service provider that is operating communication network 110.

In one example, home network 160 may include a home gateway 161, which receives data/communications associated with different types of media, e.g., television, phone, and Internet, and separates these communications for the appropriate devices. In one example, television data is forwarded to set-top boxes (STBs)/digital video recorders (DVRs) 162A and 162B to be decoded, recorded, and/or forwarded to television (TV) 163A and TV 163B for presentation. Similarly, telephone data is sent to and received from home phone 164; Internet communications are sent to and received from router 165, which may be capable of both wired and/or wireless communication. In turn, router 165 receives data from and sends data to the appropriate devices, e.g., personal computer (PC) 166, mobile devices 170A-170B, and so forth. In one example, router 165 may further communicate with TV (broadly a display) 163A and/or 163B, e.g., where one or both of the televisions is a smart TV. In one example, router 165 may comprise a wired Ethernet router and/or an IEEE 802.11 (Wi-Fi) router, and may communicate with respective devices in home network 160 via wired and/or wireless connections.

In this regard, TVs 163A and 163B, STBs/DVRs 162A and 162B, and/or home phone 164 may also comprise smart appliances with wired and/or wireless networking/communication capability, which may be remotely programmed or configured, and which may communicate one or more networks or network links. For instance, each of these devices may include a transceiver, line card, or the like for wired and/or wireless communication, such as an infrared transmitter or transceiver, an Ethernet line card, a cellular radio unit/transceiver, a transceiver for Institute for Electrical and Electronics Engineers (IEEE) 802.11 based communications (e.g., “Wi-Fi”), IEEE 802.15 based communications (e.g., “Bluetooth,” “ZigBee,” etc.), and so forth.

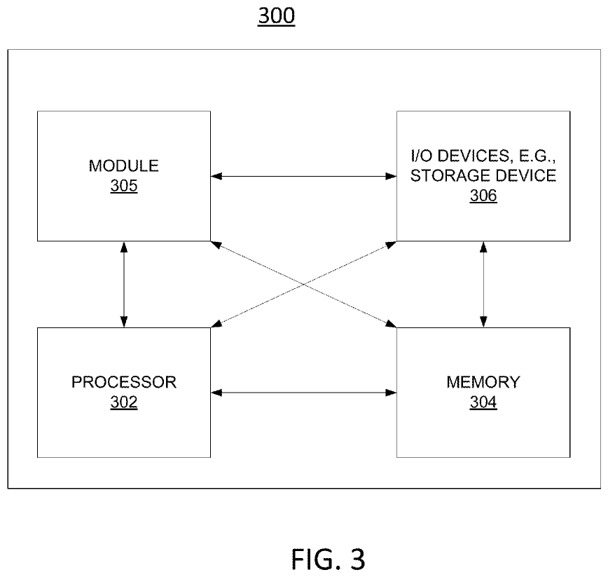

In one example, the RSP system 115 may comprise a computing system, such as computing system 300 depicted in FIG. 3, and may be configured to provide one or more functions in connection with examples of the present disclosure for a first integrated circuit of a mobile computing device to transmit at least one subscriber identity module credential to a second integrated circuit of a second computing device to enable the utilization of the at least one subscriber identity module credential by the second computing device, as described herein. For example, RSP system 115 may be configured to perform one or more steps, functions, or operations in connection with the example method 200 described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

As further illustrated in FIG. 1, the system 100 may include a remote SIM provisioning (RSP) system 180. In this regard, it should be noted that as described herein, functions of RSP system 115 may similarly be performed by RSP system 180, and vice versa. For example, RSP system 115 may be operated by the communication network 110 for subscribers thereof, while RSP system 180 may be operated by a different mobile network operator (MNO), by a virtual mobile network operator (MVNO), by a non-network operating entity, etc. For instance, both RSP system 115 and RSP system 180 may comprise subscription management (SM) entities (e.g., in accordance with the Global System for Mobile (GSM) Association (GSMA) certifications, or the like). To further illustrate, RSP system 115 may include a subscription management-secure router (SM-SR) and/or a subscription management-data preparer (SM-DP) (and similarly for RSP system 180). For illustrative purposes, examples are described herein primarily in connection with RSP system 115. However, it should be understood that in other examples, the same or similar description may likewise apply to RSP system 180.

In one example, RSP system 115 may be responsible for deploying SIM profiles to endpoint devices of subscribers of communication network 110 and/or wireless access network 150. For instance, an SM-DP component of the RSP system 115 may prepare and store SIM profiles. An SM-SR component of the RSP system may communicate with remote UICCs of endpoint devices to deploy SIM profiles and to subsequently manage the SIM profiles. For instance, mobile device 170A may include a universal integrated circuit card (UICC) 130 having a SIM 131 (e.g., a SIM profile). It should be noted that as referred to herein a subscriber identity module (SIM) may be instantiated on a SIM card (e.g., a universal integrated circuit card (UICC)), an eSIM (embedded SIM), an iSIM (integrated SIM), an iUICC (integrated UICC), or the like (e.g., in either a consumer device or an Internet of Things device, etc.) that may store an international mobile subscriber identity (IMSI) number, one or more authentication keys for authenticating the SIM to a cellular/mobile network, etc. In accordance with the present disclosure an integrated circuit or UICC may be any module that may store an integrated circuit card identifier (ICCID), a subscriber identifier (e.g., an IMSI), a telephone number (e.g., a mobile station international subscriber directory number (MSISDN)), etc., authentication key(s), user services (e.g., value-added services), local network information, personal identification number (PIN), unblocking code, and so forth.

It should also be noted that as referred to herein, a SIM and “SIM profile” may be used interchangeably. For instance, mobile device 170A may include a universal integrated circuit card (UICC) 130 (e.g., an iUICC) having a SIM 131 (e.g., a SIM profile). Similarly, mobile device 170B may include a UICC 132 having a SIM 133 installed thereon. Likewise, vehicle 191 may have a UICC 138 with SIM 139 installed thereon. In addition, although examples are described herein primarily with respect to iUICCs, it should be understood that the description may be equally applicable to other integrated circuits associated with SIMs, such as a SIM card, including embedded SIMs (eSIMs) and removable SIM cards, an integrated SIM (iSIM), and so forth. For illustrative purposes, any or all of such variants may be referred to as a UICC herein. In one example, a UICC may include a processor (e.g., a CPU), memory (e.g., read only memory (ROM), random access memory, erasable programmable ROM (EPROM), input/output ports, and so forth.

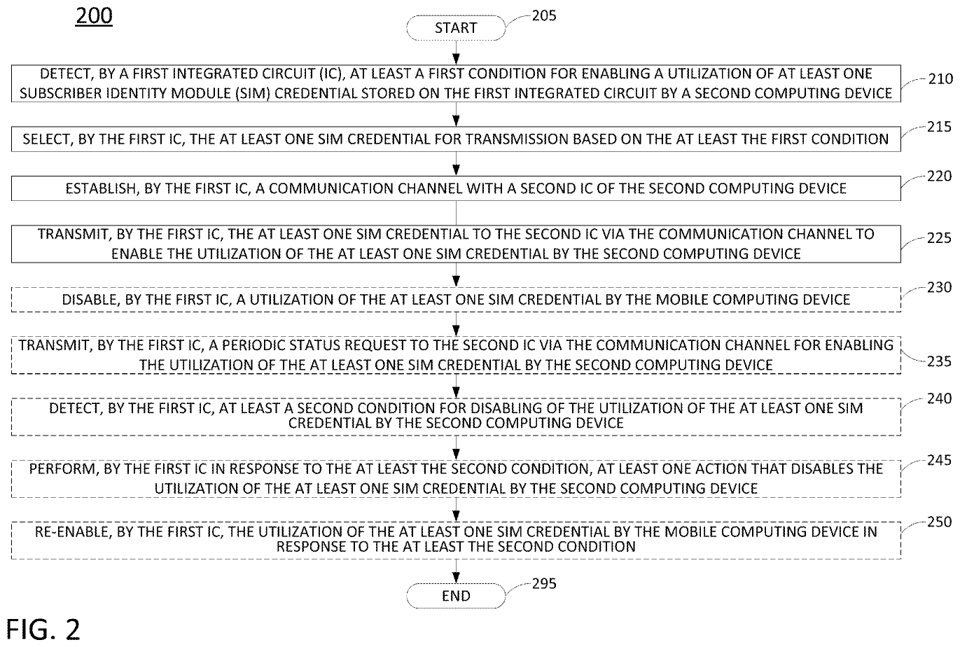

In accordance with the present disclosure, UICCs 130 and 132 may each specifically store a SIM application (applet) and implement the operations thereof. In particular, UICCs 130 and 132 may include a small processor and memory that enables the UICC to host a lightweight operating system and to store and to run applications (applets). As such, UICCs 130 and 132 may each comprise all or a portion of a computing system, such as computing system 300 depicted in FIG. 3, and may be configured to perform steps, functions, and/or operations for transmitting at least one subscriber identity module credential to a second integrated circuit of a second computing device to enable the utilization of the at least one subscriber identity module credential by the second computing device, e.g., in accordance with the example method 200 of FIG. 2 and/or as described elsewhere herein.

In one example, other devices, such as TV 136A and STB/DVR 162B, may include UICCs, such as UICCs 134 and UICC 135. In one example, these devices may not include SIM profiles of their own, or may initially come without a loaded SIM profile, where one can be installed later if a user so chooses. Alternatively, or in addition, UICC 134 may include a bootstrap profile (not shown in FIG. 1) which allows minimal connectivity, e.g., to RSP system 115 in order to load a new SIM profile. FIG. 1 further illustrates a location 199 which may include additional cellular-capable devices, such as television (TV) 192 and IoT device 193 (e.g., a smart appliance, e.g., a refrigerator, a heating, ventilation, and air conditioning (HVAC) system, etc., a biometric device, such as a smart watch, a heart rate monitor, and so forth). Notably, TV 192 may include a UICC 136 while IoT device 193 may include a UICC 137. However, initially, there may be no SIMs installed in these UICCs.

In accordance with the present disclosure, users and/or devices may lend and/or share SIM profiles or aspects thereof (e.g., SIM credentials) in accordance with various rules and/or user instructions. For instance, in an illustrative example, SIM 131 may include credentials for accessing one or more network-based media services (e.g., a video streaming service). As such, user 171A may choose to share/transfer some or all of the credentials of SIM 131 to TV 192. For example, user 171A may be travelling and may be a guest at location 199, e.g., a hotel, vacation home, or the like where TV 192 is located. As noted above, the transfer may be initiated via user instruction in the form of a gesture (e.g., detected via a camera of mobile device 170A or the like), an input via a GUI, a near-field communication (NFC) sensing between the respective devices, etc. In one example, a dedicated user application may provide a user interface to receive such instructions and/or to detect events that may trigger SIM credential transferring. Accordingly, in such an example, the application may pass instructions and/or notifications to the UICC 130, which may then implement one or more actions in response. In one example, UICC 130 may have installed thereon and may implement a SIM application, e.g., a SIM applet. For instance, in one example, the SIM applet may use 3^{rd} Generation Partnership Project (3GPP) SIM Application Toolkit (STK) commands to subscribe to events and to use the event data to determine whether and when to transfer SIM credentials, to select one or more specific SIM credentials for transfer, to identify a device to send the SIM credentials to, and so forth.

In one example, UICC 130 may communication with TV 192 via a network-based channel via a cellular network infrastructure, a cellular side-link, or a peer-to-peer non-cellular wireless channel. To illustrate, a non-cellular wireless communication channel may be in accordance with IEEE 802.15 (e.g., Bluetooth) link, a near-field communication (NFC) link, a Dedicated Short Range Communication (DSRC) link, a Wi-Fi peer-to-peer link, etc. In one example, UICC 130 may communicate with TV 192, and more specifically to the UICC 136 thereof, via a communication and security protocol over the non-cellular wireless communication channel. For instance, in one example, the communication may be in accordance with SIM Access Profile (SAP), or the like.

In one example, TV 192/UICC 136 may then utilize the SIM credentials (e.g., all or a portion of SIM 131) to obtain one or more network-based services, to access media or other data, and so forth. To further illustrate, UICC 136 may use the SIM credentials to establish access to a streaming video service of communication network 110, for example. For instance, application server(s) 114 may provide streaming video to authorized devices, such as mobile device 170A. In addition, the operator of communication network 110 may permit devices temporarily associated with authorized users/devices (such as user 171A and/or mobile device 170A) to also access streaming video via application server(s) 114.

In one example, communication network 110 may apply one or more verification criteria to determine whether to permit services using the SIM credentials by TV 192/UICC 136. For instance, the service may be permitted when the location of TV 192/UICC 136 is the same as the location of mobile device 170A/UICC 130 and/or a last detected location prior to the transfer. For instance, this may include attachment to the same cell site, or may be based upon a more specific location determination via triangulation, location reporting via global positioning system (GPS) coordinates, etc.

In one example, communication network 110 may apply a SIM-based authentication, e.g., via a SIM applet operating on UICC 130. For instance, the SIM applet may pass a query to a user-space application of the mobile device 170A requesting that the user 171A confirm approval of the transfer of the SIM credentials to TV 192/UICC 136. In one example, UICC 130 may maintain a default profile that may permit network connectivity for purposes of obtaining a SIM credential transfer confirmation request from communication network 110, e.g., even if the transfer to UICC 136 of TV 192 is for all of the SIM 131. Alternatively, or in addition, in some examples communication network 110 may maintain a list of authorized devices that may be associated with one or more SIM credentials of SIM 131. For instance, user 171A may enter a list of pre-approved devices, which may be identified by integrated circuit card identifier (ICCID), or the like.

In one example, TV 192/UICC 136 may use the SIM credentials as long as communication between UICC 136 and UICC 130 is maintained. For instance, a SAP connection may be maintained to permit continued use of the SIM credentials. In such an example, use of the SIM credentials by TV 192/UICC 136 may also be terminated by either UICC. For instance, user 171A may no longer desire to use TV 192 and may provide an instruction to revoke the access and utilization of the SIM credentials by TV 192/UICC 136. In one example, the revocation may be completed via SAP procedures. In another example, the transmittal of SIM credentials of SIM 131 to UICC 136 may be via RSP system 115. For instance, user 171A may initiate the transfer of SIM credentials of SIM 131 to TV 192/UICC 136 using an instruction that may be received via a user application and passed to a SIM applet that may communicate with RSP system 115 to initiate the transfer. In one example, RSP system 115 may verify that the transfer is authorized, e.g., according to a subscription of user 171A and/or associated with mobile device 170A, UICC 130, and/or SIM 131. When authorized, RSP system 115 may then perform remote SIM provisioning of UICC 136 to deploy the SIM credentials of SIM 131 thereto. For instance, RSP system 115 may communicate with UICC 136 using a bootstrap SIM profile of UICC 136 via wireless access network 150.

In one example, RSP system 115 may also communicate with UICC 130 (e.g., using a bootstrap SIM profile and/or residual credentials of SIM 131) to confirm that the transferred SIM credentials are disabled and/or erased from UICC 130. In one example, UICC 130 may be configured to automatically and voluntarily perform these tasks, and may provide confirmation to RSP system 115 upon audit/request. In one example, upon occurrence of one or more conditions for ending the sharing of SIM credentials, RSP system 115 may perform similar operations in the reverse direction to reinstall the SIM credentials back on UICC 130 and/or to re-enable such credentials at UICC 130, e.g., via one or more RSP communications. Similarly, RSP system 115 may disable and/or erase the SIM credentials temporarily shared with TV 192/UICC 136.

In another example, user 171B may rent vehicle 191 and may wish to temporarily enable vehicle 191 and UICC 138 to utilize all or a portion of SIM 133. For example, the vehicle 191 may include an on-board unit (OBU) equipped for cellular communications (e.g., via UICC 138, a cellular radio unit, an antenna system, etc.), for communications via an LTE sidelink, a 5G sidelink, or the like, for communications via a dedicated short range communication (DSRC) networks, via IEEE 802.11 and/or 802.15-based communications, and so forth. It should be noted that UICC 138 may already have a SIM profile (e.g., SIM 139 installed and in operation thereon). For instance, SIM 139 may be a profile for a fleet owner of the rental vehicle, which can be used for tracking the vehicle and against with charges for network utilization of smart vehicle features that may be charged (e.g., telematics, in-vehicle entertainment for passengers, etc.). In one example, a vehicle lessee may be provided with the opportunity to utilize vehicle 191 in accordance with the profile of SIM 139, e.g., for an extra fee and/or as part of the cost of the rental. However, the lessee may also have the option to utilize the lessee's own SIM profile for all or a portion of the services or other capabilities that may be facilitated by such SIM profiles. For example, the rental cost may be reduced if a lessee has SIM profile transfer capability and chooses to use the lessee's own SIM profile. Alternatively, or in addition, the lessee may consider that the lessee's SIM profile includes access or subscription levels superior to that of the SIM 139 that may be offered by the lessor. Thus, in any case, user 171B (e.g., the lessee) may seek to transfer all or a portion of SIM 133 to vehicle 191/UICC 138. In one example, the transfer may be effected in the same or similar manner as described above in connection with sharing of SIM credentials of SIM 131 from mobile device 170A/UICC 130 to TV 192/UICC 136.

Still another example may relate to the transfer of SIM credentials of SIM 131 to IoT device 193/UICC 137. For instance, user 170A may have a smart refrigerator in home network 160 (not shown) that may utilize cellular services to upload stock and consumption information of user 170A to a network based service (e.g., for a diet/health application, etc.). While the user is travelling to location 199, a smart refrigerator (e.g., IoT device 193) may be available. Advantageously, the user 170A may be permitted to transfer all or a portion of SIM 131 to UICC 137 of IoT device 193. Accordingly, IoT device 193 may then gather and upload stock and consumption data to the preferred network-based platform utilized by user 170A, where the network utilization to support such data transfer may be via the preferred network of user 170A (e.g. via wireless access network 150 and/or communication network 110), where the network utilization may be charged against the subscription of user 171A in accordance with the profile of SIM 131, and so forth.

In yet another example, user 171A may wish to share all or a portion of the profile of SIM 131 with user 171B and mobile device 170B. For instance, user 171B may be a child of user 171A. The mobile device 170B may have a restricted network access, e.g., where SIM 133 may comprise a default/bootstrap profile that is usable to communicate with the network for RSP, but which does not enable general network usage. However, a parent (e.g., user 171A) may provide SIM credentials on a temporary basis, e.g., as needed, for the child (e.g., user 171B) to obtain network services. For instance, the parent may enable the child's mobile device 170B for network services while the child is dropped off at a sports activity. When the child is picked up at a later time, the network services may be disabled, e.g., by removing the SIM credentials from device 170B. The transfer may be initiated via user input as described above (e.g., gesture, GUI input, device-to-device tapping or other NFC sensing, etc.) and may be completed in the same or similar manner as any of the foregoing examples (e.g., via non-cellular and/or peer-to-peer communication, e.g., using SAP or the like, using RSP via RSP system 115, etc.). In one example, the communication network 110 may offer subscriptions specific to such arrangements. For instance, mobile device 170B and UICC 132 may be dual/multi-SIM capable. Thus, the user 171A may maintain a primary SIM profile associated with user 171A and may also have a secondary SIM profile (e.g., SIM 131) that can be lent out and return to the UICC 130 on an ongoing basis, e.g., to one or more children of the user 171A.

Various other examples of a same or similar nature may be provided in accordance with the present disclosure, depending upon the specifics of different SIMs/SIM profiles, the entitlements, subscriptions, or the like associated with such profiles, the network(s)/network operator(s) associated with the SIM profiles, the capabilities of the cellular-ready devices to which SIM credentials may be transferred, the preferences of the users permitting such transfers, network operator restrictions which may prevent or limit such sharing in general and/or with respect to particular donors or donor devices, recipients or recipient devices, subscriber or device segments/groups, particular locations, times of day, days of the week, seasons, organization types (e.g., enterprise, academic, general public, first responder, governmental, etc.), and so forth.

In addition, it should be understood that the system 100 may be implemented in a different form than that which is illustrated in FIG. 1, or may be expanded by including additional endpoint devices, access networks, network elements, application servers, etc. without altering the scope of the present disclosure. For example, communication network 110 is not limited to an IMS network, wireless access network 150 is not limited to a UMTS/UTRAN configuration, and so forth. Similarly, the present disclosure is not limited to an IP/MPLS network for VoIP telephony services, or any particular type of broadcast television network for providing television services. Various other configurations in accordance with the present disclosure are therefore possible. For instance, as noted above functions of RSP system 115 may alternatively or additionally be performed by RSP system 180. In still another example, any functions described with respect to RSP system 115 may be performed by a separate server/platform in communication network 110. For instance, RSP system 115 may perform functions of an SM-SR and/or SM-DP, while additional functions described herein may be performed by a separate device or system that is in communication with RSP system 115. For instance, such a separate system may request that RSP system 115 remotely deploy SIM credentials to UICCs, may request that RSP system 115 revoke such credentials upon the determination that conditions for sharing or revoking access to SIM credentials is warranted, and so forth. Thus, these and other modifications are all contemplated within the scope of the present disclosure.

FIG. 2 illustrates a flowchart of an example method 200 for a first integrated circuit of a mobile computing device to transmit at least one subscriber identity module credential to a second integrated circuit of a second computing device to enable the utilization of the at least one subscriber identity module credential by the second computing device. In one example, the method 200 is performed by one or more components of the system 100 of FIG. 1, such as by one of UICCs 130, 132, 134-138, or the like in FIG. 1 (e.g., an integrated circuit (IC)) and/or any one or more components thereof (e.g., a processor, or processors, performing operations stored in and loaded from a memory), or by one or more of such integrated circuits in conjunction with one another and/or one or more other devices or systems, such as RSP system 115, RSP system 180, and so forth. In one example, the steps, functions, or operations of method 200 may be performed by a computing device or system 300, and/or processor 302 as described in connection with FIG. 3 below. For instance, the computing device or system 300 may represent any one or more components of an integrated circuit, e.g., a UICC, or the like that is/are configured to perform the steps, functions and/or operations of the method 200. Similarly, in one example, the steps, functions, or operations of method 200 may be performed by a processing system comprising one or more computing devices collectively configured to perform various steps, functions, and/or operations of the method 200. For instance, multiple instances of the computing device or processing system 300 may collectively function as a processing system. For illustrative purposes, the method 200 is described in greater detail below in connection with an example performed by a first integrated circuit, e.g., a processing system.

The method 200 begins at step 205 and proceeds to step 210. In step 210, a first integrated circuit of a mobile computing device detects at least a first condition for enabling a utilization of at least one subscriber identity module (SIM) credential stored on the first integrated circuit by a second computing device. For instance, the first integrated circuit may comprise a SIM card, an iSIM, a UICC (e.g., including an iUICC), or the like. In one example, the detecting of the at least the first condition may be in accordance with a SIM applet operating on the first integrated circuit. For instance, the SIM applet may subscribe to events via a SIM application toolkit (STK) command. In one example, the at least the first condition may comprise a gesture by a user of the mobile computing device. For instance, the gesture may be of a first gesture type of a plurality of gesture types, where each of the plurality of gesture types is associated with enabling access to a different set of one or more SIM credentials. In one example, the gesture may be detected via at least one camera of the mobile computing device. To illustrate, a first gesture may comprise snapping fingers on the left hand and then swiping the left hand in the direction of the second computing device, which may indicate a command to transfer an IMSI and/or MSISDN, phone book, and virtual private network (VPN) subscription/service credentials to the second computing device, while a second gesture may comprise clapping both hands together and pointing with one hand in the direction of the second computing device, which may indicate a command to transfer the IMSI and/or MSISDN, contact list, and recent SMS messages. In one example, the at least one gesture may comprise moving one or more virtual objects in a VR/AR environment presented by the mobile computing device (e.g., a VR and/or AR headset, or the like). Alternatively, or in addition, the gesture may be an input via a GUI by the user of the mobile computing device. For instance, the user may manipulate one or more icons representing devices and/or SIM credentials to indicate which SIM credentials may be associated with which device(s).

In step 215, the first integrated circuit selects the at least one SIM credential for transmission based upon the at least the first condition. For instance, the at least one SIM credential may comprise at least one SIM file component. To further illustrate, the at least one SIM credential may comprise an IMSI, a SIM access code (e.g., a PIN or the like), a SIM unblocking key (e.g., a PIN unblocking key (PUK) or the like), and so forth. Alternatively, or in addition, the at least one SIM credential may comprise a SIM fundamental file, a SIM elemental file, a SIM applet (e.g., a different applet than one that is for detecting the condition initiating the transfer, etc.), network operation information for at least one cellular network operator (such as a preferred roaming list, etc.), and so forth. In one example, the at least one SIM credential may also include user data that is stored on the integrated circuit such as phonebook information, at least one short message service (SMS) message, and so on.

In step 220, the first integrated circuit establishes a communication channel with a second integrated circuit of the second computing device. For instance, as described above, the communication channel may comprise a network-based channel via a cellular network infrastructure, a cellular side-link, or a peer-to-peer non-cellular wireless channel (e.g., Bluetooth or other NFC, DSRC, Wi-Fi peer-to-peer, etc.). The second integrated circuit may be of a same or similar nature as the first integrated circuit, e.g., a SIM card, an iSIM, a UICC, iUICC, or the like. In one example, a secure communication protocol may be used to transmit and receive data over the communication channel. For instance, in one example, the first integrated circuit and the second integrated circuit may communicate via a SIM access profile protocol (e.g., Bluetooth SAP, or the like). In another example, the communication channel may be indirect via a network-based device. For instance, the first integrated circuit may establish an RSP connection with a network-based RSP system (e.g., a subscription management-secure router (SM-SR) or the like) where the RSP system may further establish an RSP connection with the second integrated circuit.

In step 225, the first integrated circuit transmits the at least one SIM credential to the second integrated circuit via the communication channel to enable the utilization of the at least one SIM credential by the second computing device. For instance, step 225 may comprise transmitting all or a portion of a SIM profile from the first integrated circuit to the second integrated circuit. In one example, the SIM profile may be sent with a specific PIN or PINs set to allow or limit the use of special functions (such as limiting outbound and/or inbound calls to a list of designated telephone numbers, or the like).

In optional step 230, the first integrated circuit may disable a utilization of the at least one SIM credential by the mobile computing device. For instance, the disabling of optional step 230 may be performed in response to the transmitting of step 225. As such, two devices will not attempt to use the same SIM credentials on the network at the same time.

In optional step 235, the first integrated circuit may transmit a periodic status request to the second integrated circuit via the communication channel for enabling the utilization of the at least one SIM credential by the second computing device. For example, the first integrated circuit may maintain a connection to the second integrated circuit for continued authorization to utilize the SIM credentials. For instance, as noted above, the connection may comprise a SIM access profile (SAP) connection via a peer-to-peer communication channel.

In optional step 240, the first integrated circuit may detect at least a second condition for disabling of the utilization of the at least one SIM credential by the second computing device. For instance, the at least the second condition may comprise a failure to receive a status response (e.g., in response to a status request of optional step 235) or a receiving of a status response that is defective or unacceptable to the first integrated circuit according to one or more criteria. Alternatively, or in addition, the at least the second condition may comprise a geographic or locational condition. For instance, the first integrated circuit may define a geofence surrounding the mobile computing device. The communication channel and the authorization to access and use the SIM credential(s) by the second computing device/second integrated circuit may be terminated when the second mobile computing device exceeds the geofence boundary, when a SAP connection from client device (e.g., the second computing device) to the server e.g., the mobile computing device fails. In one example, the location of the second computing device may be self-reported to the first integrated circuit. In one example, the first integrated circuit may define a geofence for the at least one SIM credential that is transmitted. For instance, this may comprise a SIM applet that includes lightweight code to check geofence, and when the geofence is exceeded, to close any and all network connections using the SIM credentials and to erase the SIM credentials. In another example, the location of the second computing device may be detected via other mechanisms, such as signal strength detection of the communication channel, detection and reporting by a network-based system (e.g., an RSP system that may be within the communication channel between the first integrated circuit and the second integrated circuit), etc.

In optional step 245, the first integrated circuit may perform, in response to the at least the second condition, at least one action that disables the utilization of the at least one SIM credential by the second computing device. For instance, in one example, the at least one action may comprise transmitting an instruction to the second integrated circuit via the communication channel, e.g., via an SAP command/request. In another example, the at least one action may include transmitting a notification to a cellular network, where the cellular network may interact with the second integrated circuit via at least one remote command (e.g., a rewrite command and the like) to the second integrated circuit.

In optional step 250, the first integrated circuit may re-enable the utilization of the at least one SIM credential by the mobile computing device in response to the at least the second condition. Following step 225 or any of optional steps 230-250, the method 200 proceeds to step 295 where the method 200 ends.

It should be noted that the method 200 may be expanded to include additional steps, or may be modified to replace steps with different steps, to combine steps, to omit steps, to perform steps in a different order, and so forth. For instance, in one example the processing system may repeat one or more steps of the method 200, such as steps 210-225 or steps 210-250 for various additional instances of SIM credential sharing with other computing devices, and so forth. For instance, the method 200 may continue to be performed, in whole or in part, on an ongoing basis. In one example, optional step 230 may precede step 225. In one example, the method 200 may be expanded or modified to include steps, functions, and/or operations, or other features described above in connection with the example(s) of FIG. 1, or as described elsewhere herein. Thus, these and other modifications are all contemplated within the scope of the present disclosure.

In addition, although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

In one example, the present disclosure may further include a complementary method performed by the second integrated circuit, e.g., to obtain a request to transfer one or more SIM credentials from the first integrated circuit, to authorize the transfer and to participate in establishing the communication channel for such purpose, to use the SIM credentials to authenticate and to access one or more network-based services, to transmit and/or receive data over one or more networks in accordance therewith, to engage in ongoing communications with the first integrated circuit and/or an RSP server to maintain the ability to access and utilize the SIM credentials, to receive an instruction to cease the use and access of the SIM credentials, to wipe the SIM credentials from the second integrated circuit, to provide confirmation of the release/wiping of the SIM credentials by the second integrated circuit, and so forth.

Similarly, in one example, the present disclosure may further include a complementary method performed by a network-based system, e.g., an RSP system or the like, e.g., using RSP connections/sessions and RSP commands/messaging to: obtain a request to transfer one or more SIM credentials from the first integrated circuit, to authorize the transfer, to establish the communication channel (e.g., at least a portion thereof) with the second integrated circuit, to provide the SIM credentials to the second integrated circuit, to deactivate the SIM credentials on the first integrated circuit, to receive an instruction from the first integrated circuit to terminate the use and access of the SIM credentials by the second integrated circuit, to perform a remote wipe of the SIM credentials from the second integrated circuit, to provide confirmation to the first integrated circuit of the release/wiping of the SIM credentials at the second integrated circuit, to re-provision and/or re-activate the SIM credentials at the first integrated circuit, and so forth.

FIG. 3 depicts a high-level block diagram of a computing device or processing system specifically programmed to perform the functions described herein. For example, any one or more components or devices illustrated in FIG. 1 or described in connection with the method 200 may be implemented as the processing system 300. As depicted in FIG. 3, the processing system 300 comprises one or more hardware processor elements 302 (e.g., a microprocessor, a central processing unit (CPU) and the like), a memory 304, (e.g., random access memory (RAM), read only memory (ROM), a disk drive, an optical drive, a magnetic drive, and/or a Universal Serial Bus (USB) drive), a module 305 for a first integrated circuit of a mobile computing device to transmit at least one subscriber identity module credential to a second integrated circuit of a second computing device to enable the utilization of the at least one subscriber identity module credential by the second computing device, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for a first integrated circuit of a mobile computing device to transmit at least one subscriber identity module credential to a second integrated circuit of a second computing device to enable the utilization of the at least one subscriber identity module credential by the second computing device (e.g., a software program comprising computer-executable instructions) can be loaded into memory 304 and executed by hardware processor element 302 to implement the steps, functions or operations as discussed above in connection with the example method 300. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for a first integrated circuit of a mobile computing device to transmit at least one subscriber identity module credential to a second integrated circuit of a second computing device to enable the utilization of the at least one subscriber identity module credential by the second computing device (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
detecting, by a first integrated circuit of a mobile computing device, at least a first condition for enabling a utilization of at least one subscriber identity module credential stored on the first integrated circuit by a second computing device;
selecting, by the first integrated circuit, the at least one subscriber identity module credential for transmission based upon the at least the first condition;
establishing, by the first integrated circuit, a communication channel with a second integrated circuit of the second computing device; and
transmitting, by the first integrated circuit to the second integrated circuit via the communication channel, the at least one subscriber identity module credential to enable the utilization of the at least one subscriber identity module credential by the second computing device.

2. The method of claim 1, further comprising:
detecting, by the first integrated circuit, at least a second condition for disabling of the utilization of the at least one subscriber identity module credential by the second computing device; and
performing, by the first integrated circuit in response to the detecting the at least the second condition, at least one action that disables the utilization of the at least one subscriber identity module credential by the second computing device.

3. The method of claim 2, further comprising:
transmitting a periodic status request to the second integrated circuit via the communication channel for enabling the utilization of the at least one subscriber identity module credential by the second computing device.

4. The method of claim 3, wherein the at least the second condition comprises:
a failure to obtain a response to the periodic status request; or
an improper response from the second integrated circuit.

5. The method of claim 2, wherein the at least one action comprises:
transmitting a notification to a cellular network, wherein the cellular network rewrites the second integrated circuit via at least one remote command to the second integrated circuit.

6. The method of claim 1, wherein the communication channel comprises:
a network-based channel via a cellular network infrastructure;
a cellular side-link; or
a peer-to-peer non-cellular wireless channel.

7. The method of claim 1, wherein the first integrated circuit comprises:
a subscriber identity module card;
an integrated subscriber identity module;
a universal integrated circuit card; or
an integrated universal integrated circuit card.

8. The method of claim 1, wherein the detecting the at least the first condition is in accordance with a subscriber identity module applet operating on the first integrated circuit.

9. The method of claim 8, wherein the subscriber identity module applet subscribes to events via a subscriber identity module application toolkit command.

10. The method of claim 1, wherein the at least one subscriber identity module credential comprises at least one subscriber identity module file component.

11. The method of claim 10, wherein the at least one subscriber identity module credential comprises at least one of:
an international mobile subscriber identity;
a subscriber identity module access code; or
a subscriber identity module unblocking key.

12. The method of claim 10, wherein the at least one subscriber identity module credential comprises at least one of:
a subscriber identity module fundamental file;
a subscriber identity module elemental file;
a subscriber identity module applet; or
network operation information for at least one cellular network operator.

13. The method of claim 1, wherein the at least the first condition comprises a gesture by a user of the mobile computing device.

14. The method of claim 13, wherein the gesture is of a first gesture type of a plurality of gesture types, wherein each of the plurality of gesture types is associated with enabling an access to a different set of one or more subscriber identity module credentials.

15. The method of claim 13, wherein the gesture comprises:
an input via a graphical user interface by the user of the mobile computing device; or
a gesture by the user of the mobile computing device that is detected via at least one camera of the mobile computing device.

16. The method of claim 1, further comprising:
disabling a utilization of the at least one subscriber identity module credential by the mobile computing device.

17. The method of claim 16, wherein the disabling is performed in response to the transmitting.

18. The method of claim 16, further comprising:
detecting, by the first integrated circuit, at least a second condition for disabling of the utilization of the at least one subscriber identity module credential by the second computing device; and
re-enabling, by the first integrated circuit in response to the detecting the at least the second condition, the utilization of the at least one subscriber identity module credential by the mobile computing device.

19. A non-transitory computer-readable medium storing instructions which, when executed by a first integrated circuit of a first mobile computing device, cause the first integrated circuit to perform operations, the operations comprising:
detecting at least a first condition for enabling a utilization of at least one subscriber identity module credential stored on the first integrated circuit by a second computing device;
selecting the at least one subscriber identity module credential for transmission based upon the at least the first condition;
establishing a communication channel with a second integrated circuit of the second computing device; and
transmitting, to the second integrated circuit via the communication channel, the at least one subscriber identity module credential to enable the utilization of the at least one subscriber identity module credential by the second computing device.

20. A first integrated circuit comprising:
a processing system including at least one processor; and
a non-transitory computer-readable medium storing instructions which, when executed by the processing system when deployed in a first mobile computing device, cause the processing system to perform operations, the operations comprising:
detecting at least a first condition for enabling a utilization of at least one subscriber identity module credential stored on the first integrated circuit by a second computing device;
selecting the at least one subscriber identity module credential for transmission based upon the at least the first condition;
establishing a communication channel with a second integrated circuit of the second computing device; and
transmitting, to the second integrated circuit via the communication channel, the at least one subscriber identity module credential to enable the utilization of the at least one subscriber identity module credential by the second computing device.
